(19) United States
(12) Patent Application Publication
(10) Pub. No.: US 2024/0281838 A1
(43) Pub. Date: Aug. 22, 2024

(54) SERVER, MOBILE TERMINAL, AND MANAGEMENT METHOD

(71) Applicant: TOYOTA JIDOSHA KABUSHIKI KAISHA, Toyota-shi (JP)

(72) Inventor: Hiroshi MAJIMA, Tokyo (JP)

(73) Assignee: TOYOTA JIDOSHA KABUSHIKI KAISHA, Toyota-shi (JP)

(21) Appl. No.: 18/418,673

(22) Filed: Jan. 22, 2024

(30) Foreign Application Priority Data
Feb. 22, 2023 (JP) 2023-026334

(51) Int. Cl. G06Q 30/0207; H02J 7/00

(52) U.S. Cl. CPC G06Q 30/0207; H02J 7/0048

(57) ABSTRACT

The server is a server configured to communicate with a mobile terminal carried by a user. The server includes a processor that provides an incentive to the user when the amount of power stored in the battery is greater than 50% when the user uses the digital ticket.

### CROSS-REFERENCE TO RELATED APPLICATION

This application claims priority to Japanese Patent Application No. 2023-026334 filed on Feb. 22, 2023, incorporated herein by reference in its entirety.

### BACKGROUND

### 1. Technical Field

The present disclosure relates to a server, a mobile terminal, and a management method.

### 2. Description of Related Art

Japanese Unexamined Patent Application Publication No. 2003-346197 (JP 2003-346197 A) discloses an electronic ticket system using a mobile terminal equipped with a memory card storing an electronic ticket, when passing through an automatic ticket gate. As a result, even when a battery of the mobile terminal runs out or the mobile terminal malfunctions, the electronic ticket can be used by attaching the memory card to another terminal.

### SUMMARY

When an electronic ticket (a digital ticket) is used using a mobile terminal, the electronic ticket may become unusable due to the battery of the mobile terminal running out. It is desired to suppress such situations.

The present disclosure has been made in order to solve the above-mentioned issue, and an object of the present disclosure is to provide a server, a mobile terminal, and a management method that can suppress a digital ticket from becoming unusable due to a battery of the mobile terminal running out.

A server according to a first aspect of the present disclosure is configured to communicate with a mobile terminal carried by a user, and includes a processor. The mobile terminal includes a display configured to display a digital ticket for using a transportation facility, using electric power supplied from a battery included in the mobile terminal. The processor gives an incentive to the user when a power storage amount of the battery when the user uses the digital ticket is larger than a first predetermined amount.

In the server according to the first aspect of the present disclosure, as described above, the incentive is given to the user when the power storage amount of the battery when the user uses the digital ticket is larger than the first predetermined amount. Thus, it is possible to suppress the battery of the mobile terminal from running out when the digital ticket is used. As a result, it is possible to suppress the digital ticket from becoming unusable due to the battery of the mobile terminal running out.

In the server according to the first aspect, desirably, the processor further gives the incentive to the user when the power storage amount of the battery increases while the transportation facility is used by the user. With this configuration, it is possible to more reliably suppress the battery of the mobile terminal from running out when the digital ticket is used.

In the server according to the first aspect, desirably, the processor gives a penalty to the user when the power storage amount of the battery when the user uses the digital ticket is smaller than a second predetermined amount that is equal to or less than the first predetermined amount. With this configuration, since the user suppresses the consumption of the power storage amount of the battery in order to sidestep the penalty, it is possible to more reliably suppress the battery of the mobile terminal from running out when the digital ticket is used.

A mobile terminal according to a second aspect of the present disclosure is a mobile terminal carried by a user, and includes a battery, a display configured to display a digital ticket for using a transportation facility, using electric power supplied from the battery, a control device that controls the display, and a communication unit that communicates with a server. The control device performs control of transmitting a signal requesting an incentive for the user to the server through the communication unit, when a power storage amount of the battery when the user uses the digital ticket is larger than a predetermined amount.

In the mobile terminal according to the second aspect of the present disclosure, as described above, the signal requesting the incentive for the user is transmitted to the server, when the power storage amount of the battery when the user uses the digital ticket is larger than the predetermined amount. Thus, it is possible to provide a mobile terminal that can suppress the digital ticket from becoming unusable due to the battery of the mobile terminal running out.

A management method according to a third aspect of the present disclosure is a management method for managing a mobile terminal. The mobile terminal includes a display configured to display a digital ticket for using a transportation facility, using electric power supplied from a battery installed in the mobile terminal. The management method includes a step in which the mobile terminal acquires an incentive when a power storage amount of the battery when the digital ticket is used is larger than a predetermined amount.

In the management method according to the third aspect of the present disclosure, as described above, the mobile terminal acquires the incentive when the power storage amount of the battery when the digital ticket is used is larger than the predetermined amount. Thus, it is possible to provide a management method that can suppress the digital ticket from becoming unusable due to the battery of the mobile terminal running out.

According to the present disclosure, it is possible to suppress the digital ticket from becoming unusable due to the battery of the mobile terminal running out.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the configuration of a digital ticket management system according to the first embodiment;

FIG. 2 is a diagram showing the configuration of a server according to the first embodiment;

FIG. 3 is a diagram showing the configuration of the mobile terminal according to the first embodiment;

FIG. 4 is a diagram showing an example of a digital ticket;

FIG. 5 is a flow diagram showing server control according to the first embodiment;

FIG. 6 is a diagram showing the configuration of a digital ticket management system according to the second embodiment; and

FIG. 7 is a sequence diagram showing sequence control between the server and the mobile terminal according to the second embodiment.

### DETAILED DESCRIPTION OF EMBODIMENTS

Hereinafter, an embodiment of the present disclosure will be described in detail with reference to the drawings. In the drawings, the same or corresponding parts are denoted by the same reference signs and the description thereof will not be repeated.

### First Embodiment

### System Configuration

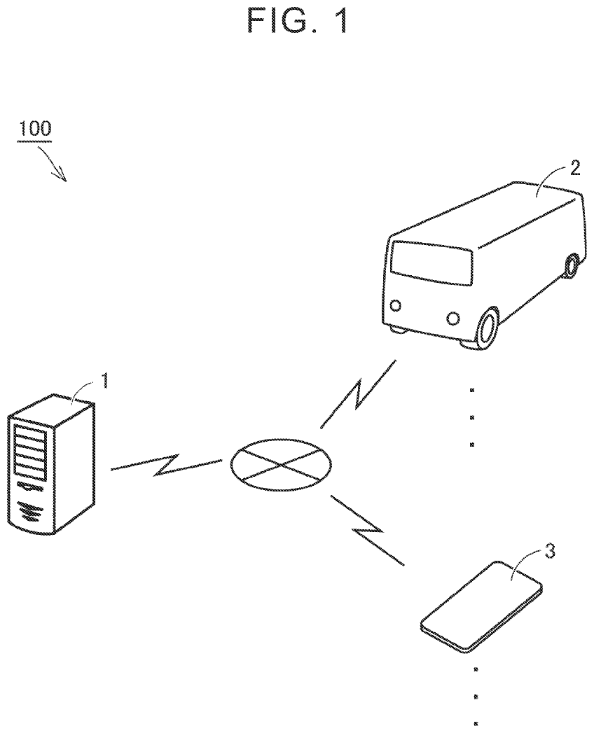

FIG. 1 is a diagram schematically showing the overall configuration of a digital ticket management system according to a first embodiment of the present disclosure. The digital ticket management system 100 includes a server 1, multiple public transportation vehicles (buses in this example) 2, and multiple mobile terminals 3. Note that public transportation is not limited to buses, and may be trains, ships, or a combination thereof. Note that the bus 2 is an example of a “transportation facility” in the present disclosure.

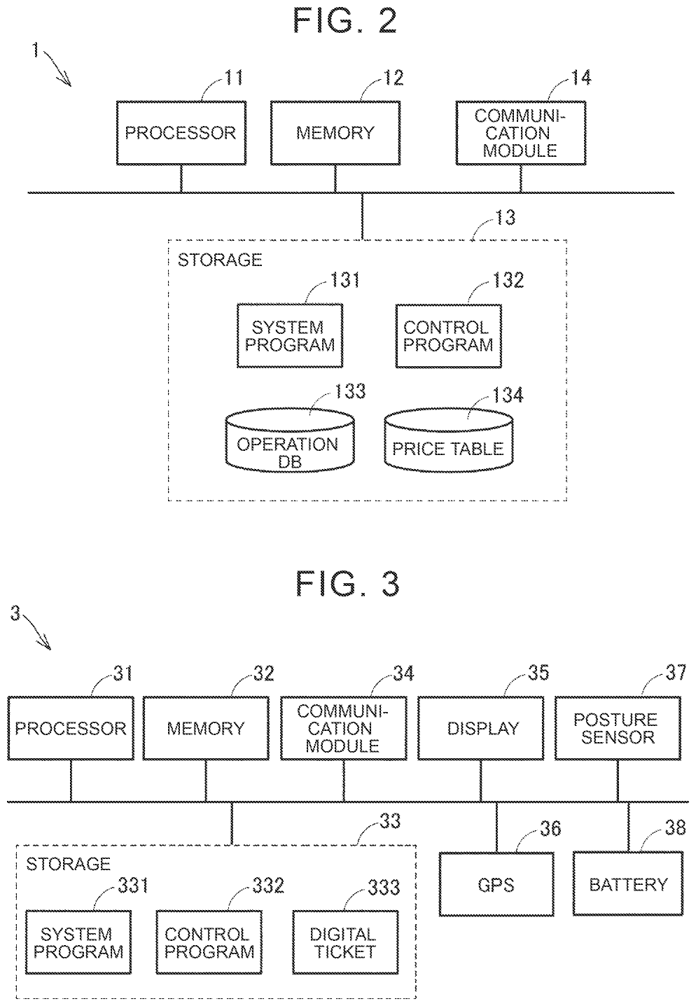

FIG. 2 is a diagram showing an example of the configuration of the server 1. The server 1 is typically a business server operated by the bus 2 business. The server 1 includes, for example, a processor 11, a memory 12, a storage 13, and a communication module 14.

The processor 11 is, for example, a microprocessor such as a Central Processing Unit (CPU) or a Micro Processing Unit (MPU). Memory 12 is volatile memory such as Random Access Memory (RAM). The processor 11 reads out a system program 131 and a control program 132 (described later), expands them into the memory 12, and executes them, thereby realizing various processes.

The storage 13 is a rewritable nonvolatile memory such as a hard disk drive (HDD), solid state drive (SSD), or flash memory. The storage 13 stores a system program 131 including an Operating System (OS), a control program 132 including computer-readable codes necessary for control calculations, an operation database 133, and a fare table 134. The operation database 133 stores the operation schedule and operation history of each of the plurality of buses 2. The fare table 134 manages boarding fares (digital ticket fares) for each of the operating routes of the plurality of buses 2.

Communication module 14 includes a communication interface with a network such as the Internet. The communication module 14 is configured to be capable of bidirectional communication with external devices of the server 1 (multiple buses 2, multiple mobile terminals 3, etc.). For example, the communication module 14 receives, from each of the plurality of mobile terminals 3, information on the State of Charge (SOC) of the battery 38, position information of the mobile terminal 3 based on the GPS module 36, etc., which will be described later, at predetermined intervals. It's okay.

FIG. 3 is a diagram showing an example of the configuration of the mobile terminal 3. The mobile terminal 3 is a terminal carried by a user (passenger) using the bus 2, and is, for example, a smartphone, a tablet, or a smart watch. The mobile terminal 3 may be a notebook personal computer (PC). The mobile terminal 3 includes, for example, a processor 31, a memory 32, a storage 33, a communication module 34, a display 35, a Global Positioning System (GPS) module 36, a posture sensor 37, and a battery 38.

The processor 31 is, for example, a microprocessor such as a CPU or an MPU. Memory 32 is volatile memory such as RAM. The processor 31 reads out a system program 331 and a control program 332 (described later), expands them into the memory 32, and executes them, thereby realizing various processes.

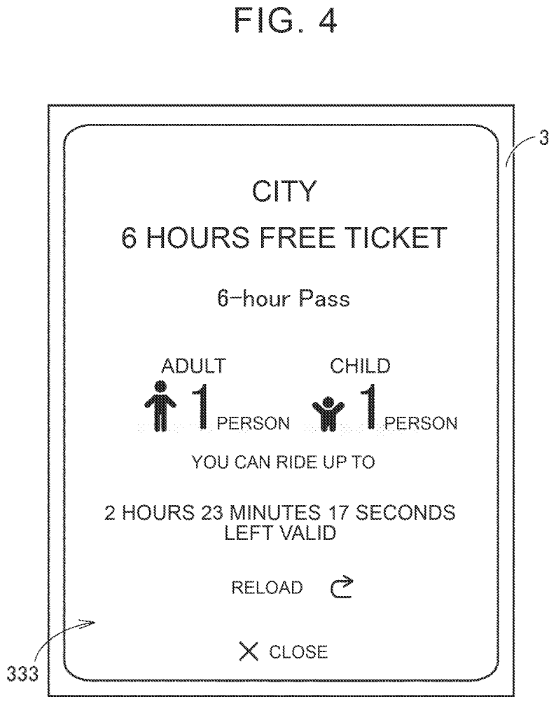

The storage 33 is a rewritable nonvolatile memory such as a flash memory. The storage 33 stores a system program 331 including an OS, a control program 332 including computer-readable codes necessary for control calculations, and a digital ticket 333. The digital ticket 333 will be explained with reference to FIG. 4.

Communication module 34 includes a communication interface that conforms to wireless communication standards. The wireless communication standard may be Long Term Evolution (LTE) such as 4G or 5G, wireless Local Area Network (LAN) such as Wireless Fidelity (Wi-Fi), or both of these. There may be. The communication module 34 is configured to be able to communicate bidirectionally with the server 1.

The display 35 is a mobile display such as organic Electro Luminescence (EL) or liquid crystal display. The display 35 is configured to display various information according to control instructions from the processor 31. In this example, the display 35 is a display with a touch panel that can accept user input operations.

The GPS module 36 acquires information (GPS information) indicating the current position of the mobile terminal 3 based on signals from a plurality of artificial satellites, and outputs the GPS information to the processor 31. Note that the mobile terminal 3 may include a beacon receiver (not shown) instead of or in addition to the GPS module 36.

The posture sensor 37 is, for example, a 3-axis acceleration sensor, a 3-axis gyro sensor, or a geomagnetic sensor. The posture sensor 37 detects the attitude (rotational movement) of the mobile terminal 3 and outputs the detection result to the processor 31.

The battery 38 stores electric power used in the mobile terminal 3. For example, display 35 displays digital ticket 333 using power supplied from battery 38.

A control program 332 (application software) for purchasing and displaying a digital ticket 333 is installed in the mobile terminal 3. By operating the mobile terminal 3, the user can purchase a desired digital ticket 333 for the route of the bus 2. Furthermore, by operating the mobile terminal 3 to display the face of the digital ticket 333 on the display 35, the user can present the digital ticket 333 to a crew member (driver, etc.) of the bus 2 when using the bus 2 (for example, when getting off the bus). This allows the user to prove that he (and his family, etc.) is a legitimate passenger.

### Display of Digital Tickets and Advertisements

FIG. 4 is a diagram showing an example of a display mode of the display 35 of the mobile terminal 3. A digital ticket 333 is displayed on the display 35. As shown in FIG. 4, the digital ticket 333 includes, for example, the boarding range (in this example, within the city), the validity period of the digital ticket 333 (in this example, 6 hours), the remaining time (in this example, more than 2 hours), and the number of adults/children (one each in this example). However, the type of digital ticket 333 is not limited to the free pass shown in FIG. 4, and any type may be used.

Here, if the mobile terminal 3 is out of battery (the power of the battery 38 is 0), the digital ticket 333 cannot be displayed on the display 35. In this case, the driver of the bus 2 or the like needs to take predetermined measures in order to allow a user who is carrying a mobile terminal 3 with a dead battery to get on or off the bus. As a result, this may cause a delay in the operation of the bus 2.

Therefore, in the first embodiment, the processor 11 of the server 1 provides an incentive to the user when the amount of electricity stored in the battery 38 is larger than a predetermined amount when the user uses the digital ticket 333. For example, the processor 11 provides an incentive to the user when the SOC of the battery 38 is greater than 50% when the user gets off the bus 2. Thereby, it is possible to prompt the user using the digital ticket 333 to maintain the SOC of the battery 38 at 50% or more. Note that the incentive may be, for example, the provision of points that can be used to pay the bus 2 fare, a discount on the bus 2 fare, or the like.

How to Incentivize Users with Digital Tickets

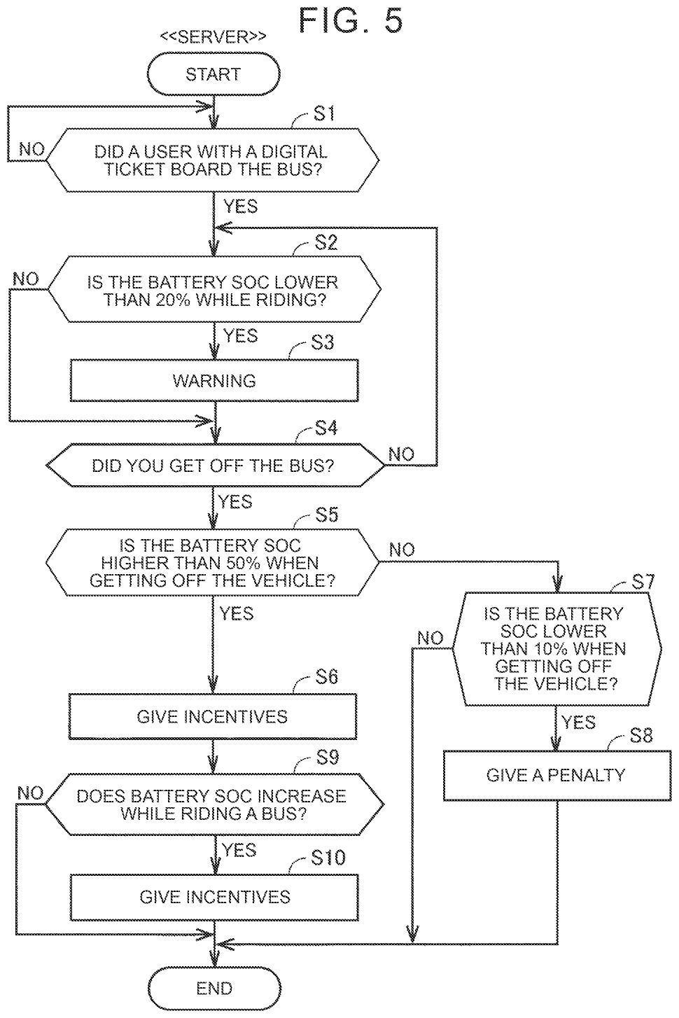

FIG. 5 shows the control flow executed by the processor 11 of the server 1. This control flow provides incentives to users who have digital tickets 333.

In S1, the processor 11 determines whether a user having a digital ticket 333 has boarded the bus 2. If the user has boarded the bus (YES in S1), the process proceeds to S2. If the user is not on the bus (NO in S1), the process in S1 is repeated.

In S1, for example, the processor 11 may detect that the user has boarded the bus 2 based on the fact that the digital ticket 333 has been read by a ticket reader provided on the bus 2. Further, the processor 11 may detect that the user has boarded the bus 2 based on the user's position information based on the GPS module 36 and the bus 2's position information. Further, the processor 11 may detect whether the user is on the bus 2 based on changes in the detected value of the posture sensor 37 caused by the user's actions when presenting the digital ticket 333 to the driver or holding the mobile terminal 3 over a ticket reader or the like. Note that the method for detecting that the user has boarded the bus 2 is not limited to the above example.

In S2, the processor 11 determines whether the SOC of the battery 38 of the mobile terminal 3 owned by the user on the bus 2 is lower than 20%. If the SOC is lower than 20% (YES in S2), the process proceeds to S3. If the SOC is 20% or more (NO in S2), the process proceeds to S4.

In S3, the processor 11 performs control to warn the user that there is a possibility of receiving a penalty due to the low SOC. Specifically, the processor 11 transmits to the mobile terminal 3 via the communication module 14 a command signal that causes the display 35 of the mobile terminal 3 to display the above warning.

In S4, the processor 11 determines whether the user has gotten off the bus 2. If the user gets off the bus (YES in S4), the process proceeds to S5. If the user has not gotten off the bus (NO in S4), the process returns to S2.

In S4, for example, the processor 11 may detect that the user has gotten off the bus 2 based on the fact that the digital ticket 333 of the user who was on the bus 2 has been read by the ticket reader. Further, the processor 11 may detect that the user has gotten off the bus 2 based on the user's position information based on the GPS module 36 and the bus 2's position information. Further, the processor 11 determines whether the user is on the bus based on a change in the detected value of the posture sensor 37 caused by the user's actions when presenting the digital ticket 333 to the driver or holding the mobile terminal 3 over a ticket reader or the like. 2 may be detected. Note that the method for detecting that the user has gotten off the bus 2 is not limited to the above example.

In S5, the processor 11 determines whether the SOC of the battery 38 when the user gets off the bus 2 is higher than 50%. If the SOC is higher than 50% (YES in S5), the process proceeds to S6. If the SOC is 50% or less (NO in S5), the process proceeds to S7. Note that the processor 11 may perform control to transmit a signal requesting information on the SOC of the battery 38 to the mobile terminal 3 when the user gets off the bus 2. Further, 50% is an example of the “first predetermined amount” and the “predetermined amount” of the present disclosure.

In S6, the processor 11 performs control to provide incentives to the user. For example, the processor 11 gives the user points or coupons that can be used when paying the fare for the bus 2 from next time onwards. Note that examples of incentives are not limited to this. Next, the process advances to S9.

In S7, the processor 11 determines whether the SOC of the battery 38 when the user gets off the bus 2 is lower than 10%. If the SOC is lower than 10% (YES in S7), the process proceeds to S8. If the SOC is 10% or more (NO in S7), the process ends. Note that 10% is an example of the “second predetermined amount” of the present disclosure.

In S8, the processor 11 performs control to give a penalty to the user. For example, the processor 11 may perform control to reduce the user's points accumulated so far, or may perform control to increase the fare for the next bus 2. Note that examples of penalties are not limited to this. The process then ends.

In S9, the processor 11 determines whether the SOC of the mobile terminal 3 increases while the user is on the bus 2. For example, when the mobile terminal 3 is charged using a mobile battery (not shown), the SOC of the mobile terminal 3 may increase. If the SOC has increased (YES in S9), the process advances to S10. If the SOC has not increased (NO in S9), the process ends.

For example, the processor 11 determines whether the amount of increase in the SOC of the battery 38 is greater than or equal to a predetermined value (for example, 5%). Specifically, the processor 11 determines whether a sum of the amount of increase in a period in which the SOC of the battery 38 increases, is equal to or greater than the predetermined value. Note that it may be determined whether the difference between the SOC when boarding and the SOC when alighting is equal to or greater than the predetermined value.

In S10, the processor 11 performs control to provide incentives to the user, similarly to S6. The process then ends. Note that the incentive in S10 may be increased according to the amount of increase in SOC corresponding to S9.

Note that the processes in S9 and S10 may be performed while the user is on the bus 2.

As described above, in the first embodiment, an incentive is given to the user when the amount of stored power (SOC) of the battery 38 is greater than 50% when the user uses the digital ticket 333. Thereby, the user refrains from consuming the SOC of the battery 38 for the sake of incentives. As a result, it is possible to suppress the mobile terminal 3 from running out of battery when using the digital ticket 333. Thereby, it is possible to suppress the need for the bus 2 crew, the secretariat, etc. to take predetermined measures due to the digital ticket 333 being unusable. As a result, it is possible to reduce the effort of the crew members of the bus 2, the secretariat, etc., and it is also possible to suppress an increase in operation costs.

### Second Embodiment

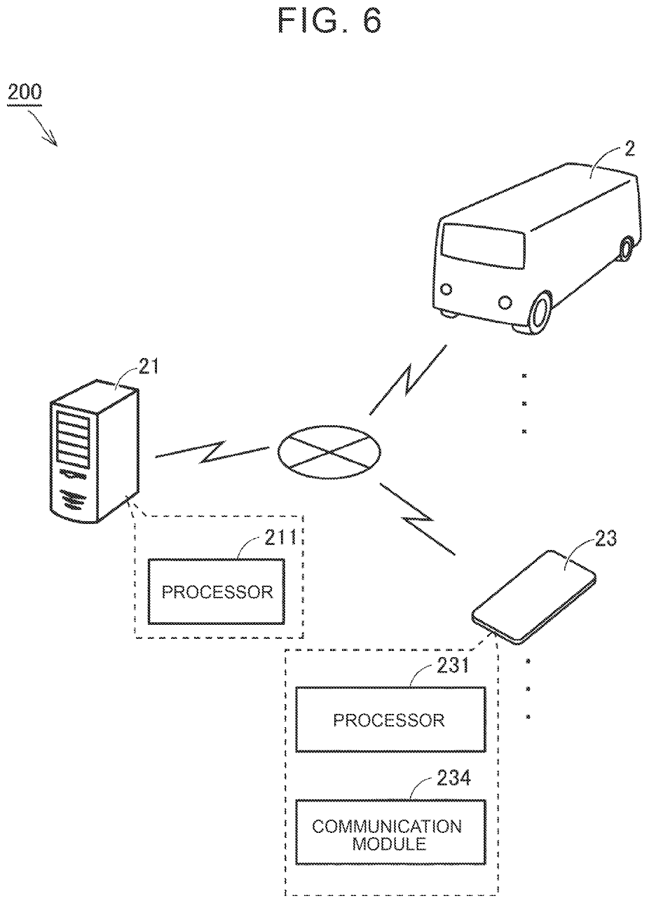

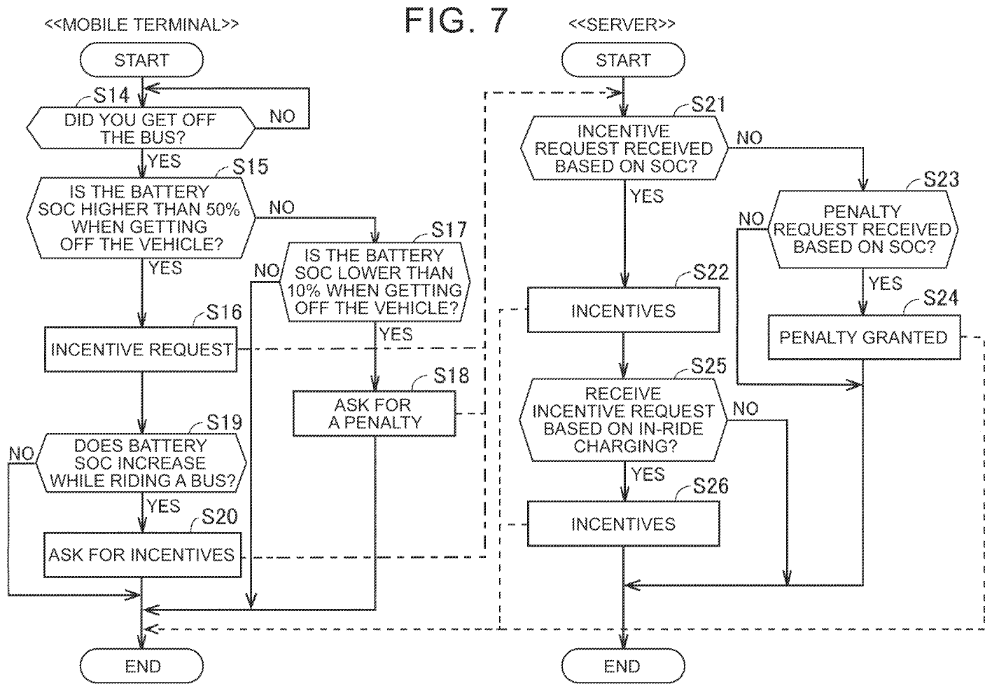

Next, a second embodiment of the present disclosure will be described with reference to FIGS. 6 and 7. In the second embodiment, the mobile terminal 23 requests the server 21 to provide an incentive.

FIG. 6 is a diagram schematically showing the overall configuration of a digital ticket management system according to a second embodiment of the present disclosure. The digital ticket management system 200 includes a server 21, a plurality of buses 2, and a plurality of mobile terminals 23. Server 21 includes a processor 211. Mobile terminal 23 includes a processor 231 and a communication module 234. Note that the processor 231 and the communication module 234 are examples of a “control device” and a “communication unit” of the present disclosure, respectively.

How to Incentivize Users with Digital Tickets

With reference to FIG. 7, a method for providing incentives to users who have digital tickets 333 will be described. The sequence shown in FIG. 7 is processing by the processor 211 of the server 21 and the processor 231 of the mobile terminal 23. Note that the processing in the processor 231 may be executed by an application installed in the mobile terminal 23.

In S14, the processor 231 of the mobile terminal 23 determines whether the user has gotten off the bus 2 or not. Note that the same processes as S1 to S3 in the first embodiment may be performed before S14, but are omitted in the second embodiment for the sake of brevity. If the user gets off the bus 2 (YES in S14), the process proceeds to S15. If the user has not gotten off the bus 2 (NO in S14), the process of S14 is repeated (or the process returns to before the process similar to S2 and S3).

In S15, the processor 231 determines whether the SOC of the battery 38 when the user gets off the bus 2 is higher than 50%. If the SOC is higher than 50% (YES in S15), the process proceeds to S16. If the SOC is 50% or less (NO in S15), the process proceeds to S17. Note that 50% is an example of the “predetermined amount” of the present disclosure.

In S16, the processor 231 controls sending a signal requesting an incentive to the server 21 through the communication module 234. Next, the process advances to S19.

In S17, the processor 231 determines whether the SOC of the battery 38 when the user gets off the bus 2 is lower than 10%. If the SOC is lower than 10% (YES in S17), the process proceeds to S18. If the SOC is 10% or more (NO in S17), the process ends.

In S18, the processor 231 controls sending a signal requesting a penalty to the server 21 through the communication module 234.

In S19, the processor 231 determines whether the SOC of the battery 38 has increased while the user is on the bus 2. If the SOC has increased (YES in S19), the process advances to S20. If the SOC has not increased (NO in S19), the process ends.

In S20, the processor 231 controls sending a signal requesting an incentive to the server 21 through the communication module 234. The process then ends. Note that the incentive in S20 may be increased according to the amount of increase in SOC corresponding to S19.

Note that the processes in S19 and S20 may be performed while the user is on the bus 2.

In S21, the processor 211 of the server 21 determines whether an incentive request based on the SOC of the battery 38 (the request in S16) has been received. If the above request has been received (YES in S21), the process proceeds to S22. At this time, it may be determined whether the above request is appropriate by referring to the SOC value of the battery 38. If the above request has not been received (NO in S21), the process proceeds to S23.

In S22, the processor 211 performs control to provide incentives to the user. After that, the process proceeds to S25.

In S23, the processor 211 determines whether a penalty request based on the SOC of the battery 38 (the request in S18) has been received. If the above request has been received (YES in S23), the process proceeds to S24. At this time, it may be determined whether the above request is appropriate by referring to the SOC value of the battery 38. If the above request has not been received (NO in S23), the process ends.

In S24, the processor 211 performs control to give a penalty to the user. The process then ends.

In S25, the processor 211 determines whether a request for an incentive based on an increase in the SOC during riding (the request in S20) has been received. If the above request has been received (YES in S25), the process proceeds to S26. At this time, it may be determined whether the above request is appropriate by referring to the amount of change in the SOC of the battery 38. If the above request has not been received (NO in S25), the process ends.

In S26, the processor 211 performs control to provide incentives to the user. The process then ends.

Note that the other configurations are the same as those in the first embodiment, so repeated description will not be given.

In the first and second embodiments described above, an example is shown in which an incentive is given when the SOC of the battery 38 at the time of getting off the bus 2 is larger than a predetermined amount (50%), but the present disclosure is not limited to this. An incentive may be given when the SOC at the time of boarding the bus 2 is larger than a predetermined amount. Further, an incentive may be given when the SOC while riding the bus 2 (between the boarding point and the alighting point) is larger than a predetermined amount.

In the first and second embodiments described above, an example was shown in which a penalty is given when the SOC of the battery 38 is smaller than 10% when the digital ticket 333 is used, but the present disclosure is not limited to this. Control that imposes a penalty may not be performed.

In the first and second embodiments described above, an example was shown in which an incentive is provided when the SOC of the battery 38 increases while riding the bus 2, but the present disclosure is not limited to this. For example, an incentive may be given when it is detected that an operation to charge the mobile terminal 3 has been performed while riding the bus 2, regardless of the amount of increase in the SOC. Further, an incentive may be given based on the fact that processing for suppressing a decrease in SOC (for example, changing to power saving mode or turning off the power) is performed while riding the bus 2.

The embodiments disclosed this time should be considered to be illustrative in all respects and not restrictive. The scope of the present disclosure is indicated by the claims rather than the description of the embodiments described above, and it is intended that all changes within the meaning and range equivalent to the claims are included.

What is claimed is:

1. A server configured to communicate with a mobile terminal carried by a user, the server comprising a processor, wherein:
the mobile terminal includes a display configured to display a digital ticket for using a transportation facility, using electric power supplied from a battery included in the mobile terminal; and
the processor gives an incentive to the user when a power storage amount of the battery when the user uses the digital ticket is larger than a first predetermined amount.

2. The server according to claim 1, wherein the processor further gives the incentive to the user when the power storage amount of the battery increases while the transportation facility is used by the user.

3. The server according to claim 1, wherein the processor gives a penalty to the user when the power storage amount of the battery when the user uses the digital ticket is smaller than a second predetermined amount that is equal to or less than the first predetermined amount.

4. A mobile terminal carried by a user, the mobile terminal comprising:
a battery;
a display configured to display a digital ticket for using a transportation facility, using electric power supplied from the battery;
a control device that controls the display; and
a communication unit that communicates with a server, wherein the control device performs control of transmitting a signal requesting an incentive for the user to the server through the communication unit, when a power storage amount of the battery when the user uses the digital ticket is larger than a predetermined amount.

5. A management method for managing a mobile terminal, wherein:
the mobile terminal includes a display configured to display a digital ticket for using a transportation facility, using electric power supplied from a battery installed in the mobile terminal; and
a step in which the mobile terminal acquires an incentive when a power storage amount of the battery when the digital ticket is used is larger than a predetermined amount, is included.
